(19) United States
(12) Patent Application Publication
(10) Pub. No.: US 2017/0017201 A1
(43) Pub. Date: Jan. 19, 2017

(54) PLATE FOR CREATING HOLOGRAMS AND METHOD FOR MANUFACTURING THE PLATE

(71) Applicant: HEIDELBERGER DRUCKMASCHINEN AG, HEIDELBERG (DE)

(72) Inventors: MARTIN SCHMITT-LEWEN, HEIDELBERG (DE); BERNHARD BUCK, HEIDELBERG (DE); MICHAEL THELEN, HOCKENHEIM (DE)

(21) Appl. No.: 15/211,043

(22) Filed: Jul. 15, 2016

(30) Foreign Application Priority Data
Jul. 15, 2015 (DE) 102015213236.6

(51) Int. Cl. G03H 1/02; B41C 1/08

(52) U.S. Cl. CPC G03H 1/028; B41C 1/08; G03H 2001/0296

(57) ABSTRACT

A plate for creating holograms or other light-bending or diffractive microstructures on web-shaped or sheet-shaped printing substrates includes a relief for a relief printing process. The relief is formed of one or more raised dies and one or more adjacent depressions. A non-metallic microrelief for printing or embossing the microstructure is provided exclusively on the dies. The plate may be manufactured in a process in which a primary plate has a negative of the microrelief and the microrelief is created by molding the negative.

### CROSS-REFERENCE TO RELATED APPLICATION

This application claims the priority, under 35 U.S.C. §119, of German Patent Application DE 10 2015 213 236.6, filed Jul. 15, 2015; the prior application is herewith incorporated by reference in its entirety.

### BACKGROUND OF THE INVENTION

### Field of the Invention

The present invention relates to a plate for creating holograms or other light-bending or diffractive microstructures on web-shaped or sheet-shaped printing substrates.

The present invention further relates to a manufacturing process for manufacturing a plate for creating holograms or other light-bending or diffractive microstructures on web-shaped or sheet-shaped printing substrates.

Such plates are fixed to a cylinder, for instance a printing press cylinder, to print or emboss the holograms. The holograms may be security features on product packaging.

German Patent Application DE 10 2013 016 117 A1, corresponding to U.S. Patent Application Publication US 2014/0109782, discloses a silicone sheet, known as a silicone shim, that has a microembossing structure for holograms.

### SUMMARY OF THE INVENTION

It is accordingly an object of the invention to provide a plate suitable for creating partial holograms, also known as spot holograms, and to provide a method suitable for manufacturing such a plate, which overcome the hereinafore-mentioned disadvantages of the heretofore-known devices and methods of this general type.

With the foregoing and other objects in view there is provided, in accordance with the invention, a plate for creating holograms or other light-bending or diffractive microstructures on web-shaped or sheet-shaped printing substrates. The plate includes a relief for a relief printing process. The relief is formed of one or more raised dies and one or more adjacent or neighboring depressions. The relief includes a microrelief disposed exclusively on the dies for printing or embossing the microstructure. The microrelief is non-metallic. Thus the microrelief is formed of a non-metallic material, for instance a cured silicone material, that was a fluid before it was cured.

With the objects of the invention in view, there is also provided a manufacturing process in which a plate for creating holograms or other light-bending or diffractive microstructures on web-shaped or sheet-shaped printing substrates is manufactured. The manufactured plate includes a relief for a relief printing process. The relief is formed of one or more raised dies and one or more adjacent or neighboring depressions. The relief includes a microrelief disposed exclusively on the dies for printing or embossing the microstructure. In the manufacturing process, a primary plate is provided with a negative of the microrelief and the microrelief is created by molding the negative.

Other features which are considered as characteristic for the invention are set forth in the appended claims.

Although the invention is illustrated and described herein as embodied in a plate for creating holograms and a method for manufacturing the plate, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, partly-sectional view of a roller unit manufacturing a plate for creating holograms;

FIG. 2 is a fragmentary, side-elevational view of a manufactured plate without an assembly carrier layer;

FIG. 3 is a fragmentary, side-elevational view of a manufactured plate with an assembly carrier layer; and

FIG. 4 is a fragmentary, side-elevational view of a primary plate for manufacturing the plate.

### DETAILED DESCRIPTION OF THE INVENTION

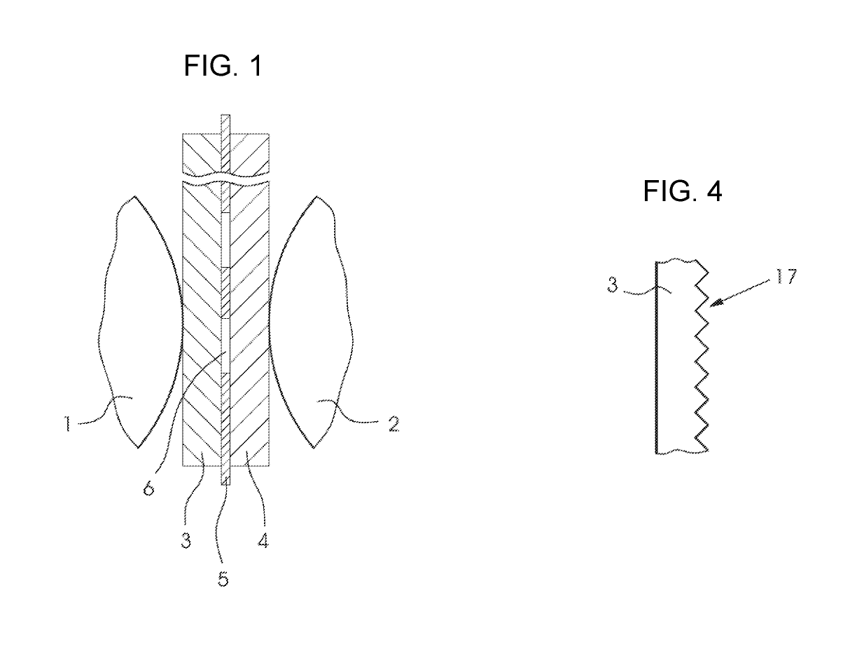

Referring now in detail to FIGS. 1 to 4 of the drawings, in which mutually corresponding elements have the same reference numeral, there is seen a roller unit including a first roller 1 and a second roller 2 pressing a stack between one another. The stack is formed of a primary plate 3, a plate-shaped blank 4, as well as a sheet-shaped stencil or mask 5 and a film-shaped fluid 6 disposed therebetween. The fluid is a curable silicone material. The blank 4 is formed of multiple layers disposed on top of one another, a fact which is not discernible in FIG. 1.

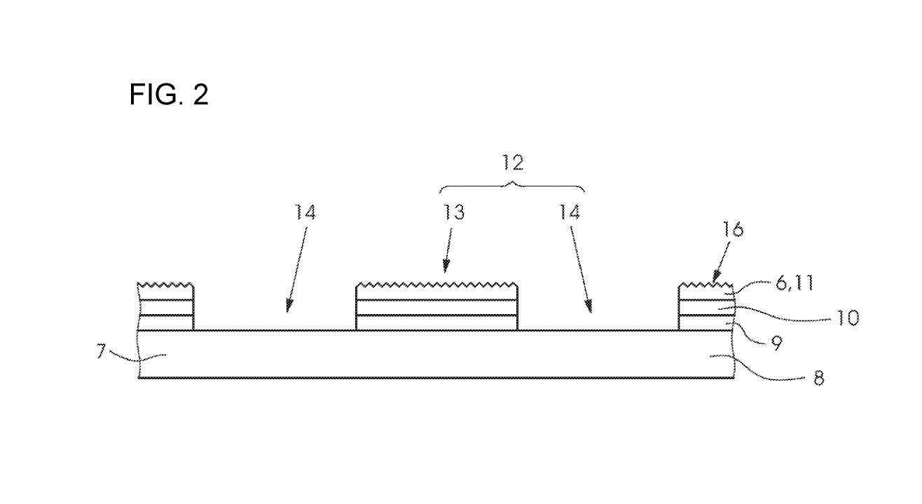

FIG. 2 illustrates a first embodiment of the construction of a plate 7 for creating holograms on web-shaped or sheet-shaped printing substrates. The plate 7, which may be referred to as a secondary plate, has been manufactured out of the blank 4 (see FIG. 1) and includes a basic carrier layer 8, one or more intermediate layers 9 disposed thereon, an intermediary layer 10 disposed thereon, and a structuring layer 11 disposed thereon as a covering layer. The layers 8, 9, 10, 11 are made of different materials. The plate 7 has a job-specific relief 12 for a relief printing process being formed of raised dies 13 and depressions 14 disposed therebetween. The dies 13 are formed by the one or more intermediate layers 9, the intermediary layer 10, and the structuring layer 11. In the region of the depressions 14, these layers 9, 10, 11 are missing and only the basic carrier layer 8 is still present. Exclusively in the region of the dies 13 the plate 7 has a microrelief 16 introduced in the structuring layer 11. The structuring layer 11 has been created from the fluid 6.

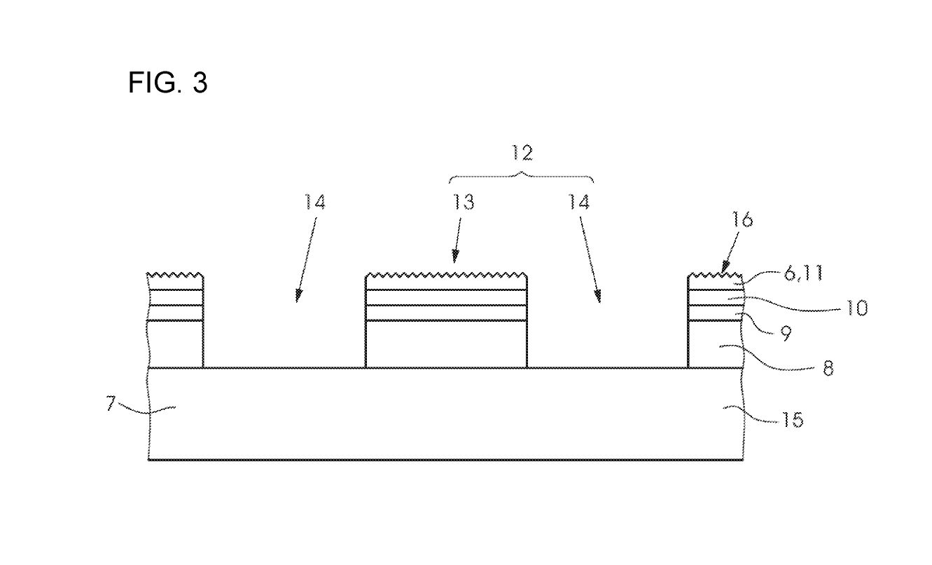

FIG. 3 illustrates a second embodiment of the construction of a plate 7 for creating holograms on web-shaped or sheet-shaped printing substrates. The plate 7, which may be referred to as a secondary plate, has been created from the blank 4 (see FIG. 1) and includes an assembly carrier layer 15, the basic carrier layer 8, the one or more intermediate layers 9, the intermediary layer 10, and the structuring layer 11 as the covering layer, all disposed on top of one another. The layers 8, 9, 10, 11, 15 are made of different materials. The plate 7 has a job-specific relief 12 for a relief printing process being formed of the raised dies 13 and the depressions 14 disposed therebetween. The dies 13 are formed by the basic carrier layer 8, the one or more intermediate layers 9, the intermediary layer 10, and the structuring layer 11. In the region of the depressions 14, these layers 9, 10, 11 are missing and only the assembly carrier layer 15 is still present. Exclusively in the region of the dies 13, the plate 7 has the microrelief 16, which is introduced in the structuring layer 11. The structuring layer 11 has been created from the fluid 6.

FIG. 4 shows that the primary plate 3 has a negative 17 of the microrelief 16. The negative 17 covers the entire primary plate 3, i.e. it is not job-specific. An advantage of the invention is that one and the same primary plate 3 may be used to manufacture different plates for different holograms for different print jobs.

The first and second constructions of the plate 7 may be created in a first manufacturing process. In the first manufacturing process, the blank 4 of the plate 7 is provided with the dies 13 in a first step. In a second step, the blank 4 and the primary plate 3 are pressed together, trapping the fluid 6 between the blank 4 and the primary plate 3 and in the process, applying at least a part of the fluid 6 to the blank 4 and molding the negative 17 exclusively in the fluid 6 applied to the dies 13 of the relief 12. In the first step, the blank 4 of the plate 7 is provided with the dies 13 by ablating material in the regions of the depressions 14. The ablation of the material may be achieved by cutting, laser treatment, or etching. The second step is carried out in the roller unit shown in FIG. 1, but without the stencil or mask. The fluid 6, which forms the structuring layer 11, is cured, for instance by irradiation, after the second step, to fix or harden the microrelief 16 in the structuring layer 11.

The manufacturing of the first and second construction alternatives of the plate 7 may be achieved in a second manufacturing process. In this process, in a first step, the blank 4 of the plate 7 and the primary plate 3 are pressed together, trapping the fluid 6 between the blank 4 and the primary plate 3 and, in this process, applying at least a part of the fluid 6 to the entire surface of the blank 4 and molding the negative 17 in the applied fluid 6 and, in a second step, the blank 4 is provided with the dies 13. The first step is carried out in the roller unit shown in FIG. 1, but without the stencil or mask. In the second step, the blank 4 of the plate 7 is provided with the dies 13 by ablating material in the regions of the depressions 14. The ablation of the material may be achieved by cutting, laser treatment, or etching. The fluid 6, which forms the structuring layer 11, is cured, for instance by irradiation, after the second step, to fix or harden the microrelief 16 in the structuring layer 11.

The manufacturing of the first and second construction alternatives of the plate 7 may be achieved in a third manufacturing process. In this process, the blank 4 of the plate 7 and the primary plate 3 are pressed together, trapping the fluid 6 and the stencil or mask 5 between the blank 4 and the primary plate 3 when the negative 17 is formed. There are three options for placement of the stencil or mask 5.

In accordance with the first option, the stencil or mask 5 is connected to the primary plate 3 before and during the pressing operation and is removed from the primary plate 3 after the pressing operation. The stencil or mask 5 may be formed by a varnish that is applied to the primary plate 3 and cured thereon and is washed off the primary plate 3 once the plate 7 is finished, allowing the primary plate 3 to be re-coated with a print job-specific stencil or mask of varnish in order to create another plate for a different print job. Alternatively, the stencil or mask 5 may be formed by a self-adhesive film that adheres to the primary plate 3 and is pulled off the primary plate 3 once the plate 7 is finished, subsequently allowing another self-adhesive film to be applied to the primary plate 3 as a stencil or mask 5 in order to create another plate for a different print job.

In accordance with the second option, the stencil or mask 5 is connected to the blank 4 before and during the pressing operation and is removed from the blank 4 after the pressing operation. The stencil or mask 5 may be formed by a varnish that is applied to the blank 4 and cured thereon and is washed off the blank 4 once the plate 7 is finished. Alternatively, the stencil or mask 5 may be formed by a self-adhesive film that adheres to the blank 4 and is pulled off the blank 4 once the plate 7 is finished.

In accordance with the third option, the stencil or mask 5 is separate from both the primary plate 3 and the blank. The stencil or mask 5 may be formed by a film that is loosely placed between the primary plate 3 and the blank 4 to form the stack (see FIG. 1) that runs through the roller unit during the pressing operation.

In all three options, the stencil or mask 5 has a thickness corresponding to the height of the structuring layer 11 and one or more recesses having outlines which correspond to those of the dies 13. In the pressing operation, at least a part of the fluid 6 is displaced into the recesses of the stencil or mask 5, where it is applied to the blank 4.

1. A plate for creating holograms or other light-bending or diffractive microstructures on web-shaped or sheet-shaped printing substrates, the plate comprising:
a relief for a relief printing process;
said relief being formed of at least one raised die and of at least one depression adjacent said at least one die; and
said relief having a microrelief for printing or embossing the microstructure, said microrelief being exclusively disposed on said dies and being non-metallic.

2. A process for manufacturing a plate for creating holograms or other light-bending or diffractive microstructures on web-shaped or sheet-shaped printing substrates, the process comprising the following steps:
forming a relief on the plate for a relief printing process;
providing the relief with at least one raised die and at least one depression adjacent the at least one die;
providing the relief with a microrelief for printing or embossing the microstructure, the microrelief being exclusively disposed on the at least one die; and
creating the microrelief by providing a primary plate with a negative of the microrelief and molding the negative to create the microrelief.

3. The manufacturing process according to claim 2, which further comprises:
in a first step, providing a blank of the plate with the at least one die; and
in a second step, pressing the blank and the primary plate together and trapping a fluid between the blank and the primary plate while applying at least a part of the fluid to the blank and molding the negative exclusively into the fluid applied to the at least one die of the relief.

4. The manufacturing process according to claim 3, wherein the fluid is a curable silicone material.

5. The manufacturing process according to claim 3, which further comprises in the first step, providing the blank of the plate with the at least one die by ablating material in a vicinity of the at least one depression.

6. The manufacturing process according to claim 2, which further comprises:
in a first step, pressing a blank of the plate and the primary plate together and trapping a fluid between the blank and the primary plate while applying at least a part of the fluid to an entire surface of the blank and molding the negative into the applied fluid; and
in a second step, providing the blank with the at least one die.

7. The manufacturing process according to claim 6, wherein the fluid is a curable silicone material.

8. The manufacturing process according to claim 6, which further comprises in the second step, providing the blank of the plate with the at least one die by ablating material in a vicinity of the at least one depression.

9. The manufacturing process according to claim 2, which further comprises carrying out the step of molding the negative by pressing a blank of the plate and the primary plate together and trapping a fluid and a stencil or mask between the blank and the primary plate.

10. The manufacturing process according to claim 9, wherein the fluid is a curable silicone material.

11. The manufacturing process according to claim 9, which further comprises keeping the stencil or mask connected to the primary plate prior to and during the pressing step and removing the stencil or mask from the primary plate after the pressing step.

12. The manufacturing process according to claim 9, which further comprises keeping the stencil or mask connected to the blank prior to and during the pressing step and removing the stencil or mask from the blank after the pressing step.

13. The manufacturing process according to claim 9, wherein the stencil or mask is separate both from the primary plate and from the blank.
